(19) United States
(12) Patent Application Publication
(10) Pub. No.: US 2004/0181563 A1
(43) Pub. Date: Sep. 16, 2004

(54) Calculating device capable of performing arithmetical operations for discount

(75) Inventors: Ming Wei Chuang, Taipei (TW); Ming Chih Chen, Taipei (TW)

Correspondence Address: BROWDY AND NEIMARK, P.L.L.C., 624 NINTH STREET, NW, SUITE 300, WASHINGTON, DC, 20001-5303, US

(73) Assignee: Kingpo Electronics, Inc., Taipei (TW)

(21) Appl. No.: 10/387,557

(22) Filed: Mar. 14, 2003

(51) Int. Cl. G06F 3/00

(52) U.S. Cl. 708/160

(57) ABSTRACT

A calculating device installed in a calculator capable of performing arithmetical operations for discount is disclosed. The calculating device comprises a microprocessor for controlling the operations of the calculator; a discount calculating unit electrically connected to the microprocessor, the discount calculating unit being used to perform arithmetical operations for discount; an input unit electrically connected to the microprocessor, wherein the input unit comprises a plurality of discount operation keys installed on the calculator, and wherein when the discount operation keys are pressed orders for calculating arithmetical operations for discount are sent to the microprocessor; a random access memory electrically connected to the microprocessor, the random access memory being used to store data generated during the arithmetical operations for discount; and a display screen electrically connected to the microprocessor for displaying the data generated during the arithmetical operations for discount.

### BACKGROUND OF THE INVENTION

1. Field of the Invention

The present invention relates to a calculating device capable of performing arithmetical operations for discount and related method. More particularly, the present invention relates to a calculating device capable of performing arithmetical operations for discount to find the original price, sale price, or the amount of discount. The calculating device of the present invention may be installed in a commercial calculator, an engineering calculator, calculator of a PDA, a cell phone, or an electronic translator.

2. Description of the Prior Art

Stores often sell items for a discounted sales price. The stores discount an item by a percent of the original price. Because it is often difficult to calculate mentally the amount of discount from the discount rate and the original price (the amount of discount=the original price×the discount rate) and also the sale price (the sale price=the original price−the amount of discount), a customer or the merchant often needs a calculator to find out the sale price.

For example, an item that originally cost $123 may be discounted by 38%. To find the amount of discount calculate 25% of $123. ($128×38%=$46.74) Then the merchant or the customer has to subtract the discount from the original price to find the sale price. ($123-$46.74=$76.26 sales price).

However, when the merchant or the customer uses mental arithmetic or a calculator to calculate the sales price, the calculating process often takes too long to keep the customers waiting. Sometimes, careless input error occurs, and often the customers give the merchant more money than the amount due because the input error when using a calculator. Consequently, there is a need to provide an improved calculating device to solve the above-mentioned problem.

### SUMMARY OF THE INVENTION

The main objective of the invention is to provide a calculating device capable of performing arithmetical operations for discount.

According to the claimed invention, a calculating device capable of performing arithmetical operations for discount is disclosed. The calculating device is installed in a calculator. The calculating device comprises a microprocessor for controlling the operations of the calculator; a discount calculating unit electrically connected to the microprocessor, the discount calculating unit being used to perform arithmetical operations for discount; an input unit electrically connected to the microprocessor, wherein the input unit comprises a plurality of discount operation keys installed on the calculator, and wherein when the discount operation keys are pressed orders for calculating arithmetical operations for discount are sent to the microprocessor; a random access memory electrically connected to the microprocessor, the random access memory being used to store data generated during the arithmetical operations for discount; and a display screen electrically connected to the microprocessor for displaying the data generated during the arithmetical operations for discount.

From one aspect of the present invention, a calculating method for performing arithmetical operations for discount is disclosed. The method comprises

(a) inputting a discount value through an input unit to store the discount value in a random access memory;

(b) inputting an original price of an item on sale through the input unit to store the original price in the random access memory;

(c) pressing a DISCOUNT key of the input unit;

(d) calculating a sale price of the item on sale according to a first equation using the discount value and the original price stored in a random access memory which is performed by a microprocessor; and

(e) outputting the resultant sale price on a display screen.

From another aspect of the present invention, a calculating method for performing arithmetical operations for discount, wherein through the calculating method, an original price, an amount of discount, and a sale price can be calculated by inputting two values of the original price, amount of discount, and sale price to find the other, the calculating method comprises:

(a) inputting two known values of the original price, amount of discount, and sale price through an input unit to store the values in a random access memory;

(b) processing the two known values of the original price, amount of discount, and sale price by a microprocessor to find the other value of the original price, amount of discount, and sale price according to an equation; and

(c) outputting the resultant value on a display screen.

From another aspect of the present invention, an recording medium loaded with a software procedure capable of performing discount operations, the software procedure comprises: first procedure code for inputting values through discount operation keys of input unit; second procedure code for storing the inputted values through the discount operation keys of input unit in a random access memory; third procedure code for calculating the values stored in the random access memory according to equations to find sale price, and fourth procedure code for displaying the result.

Other objects, advantages and novel features of the invention will become more clearly and readily apparent from the following detailed description when taken in conjunction with the accompanying drawings.

### BRIEF DESCRIPTION OF THE DRAWINGS

FIG. 1 is a block diagram schematically illustrating the calculating device of the present invention.

FIG. 2 is a flowchart showing the first approach according to the present invention.

FIG. 3 is a flowchart showing the second approach according to the present invention.

### DETAILED DESCRIPTION OF THE PREFERRED EMBODIMENTS

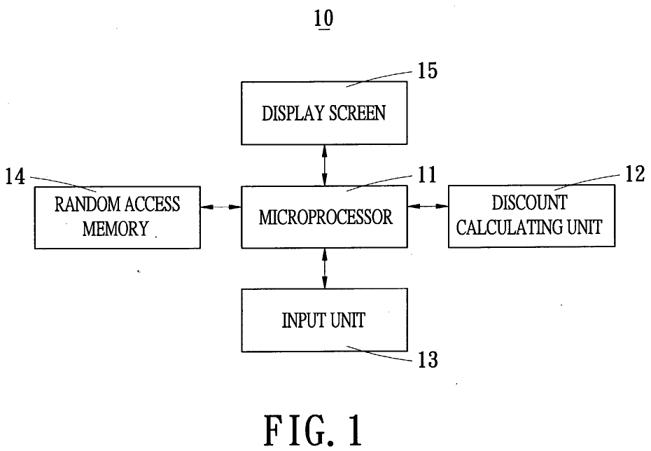

Please refer to FIG. 1. FIG. 1 is a block diagram schematically illustrating the calculating device of the present invention. The calculating device is a calculator 10 comprising a microprocessor 11, a discount calculating unit 12, an input unit 13, a random access memory (RAM) 14, and a display screen 15.

The microprocessor 11 is used to control the operations of the calculator 10 and is electrically connected to discount calculating unit 12, the input unit 13, the random access memory 14, and the display screen 15. The discount calculating unit 12 is used to calculate the sale price or the amount of discount from the original price and the discount rate. The input unit 13 of the calculator 10 is a keypad comprising number keys, symbol keys, operation keys (+, −, ×, ÷), a SET key for calculating discount operations, a PRICE key for inputting the original price, a DISCOUNT key for inputting a discount rate, and a SALE key for calculating the sale price. The random access memory 14 of the calculator 10 is used to temporarily store data input during the calculating operations. The display screen 15 is preferably a liquid crystal display (LCD) screen used to display numbers, symbols, or data during the calculating operations.

The discount calculating unit 12 calculates relevant amount of money according to several pre-determined equations including:

A. Equation for calculating the price after discount.

The original price×(1-discount rate) equation (1)

B. Equation for calculating the amount of discount.

The original price×discount rate equation (2)

C. Equation for calculating the original price (PRICE) from the known sale price (SALE) and the discount rate (DISCOUNT).

SALE/DISCOUNT equation (3)

D. Equation for calculating the discount rate (DISCOUNT) from the known original price (PRICE) and the sale price (SALE).

SALE/PRICE equation (4)

E. Equation for calculating the sale price (SALE) from the known original price (PRICE) and the discount rate (DISCOUNT).

PRICE×DISCOUNT equation (5)

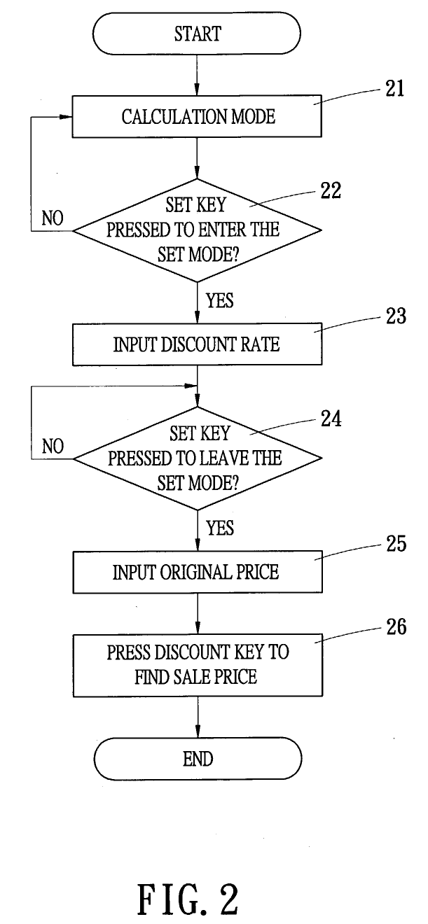

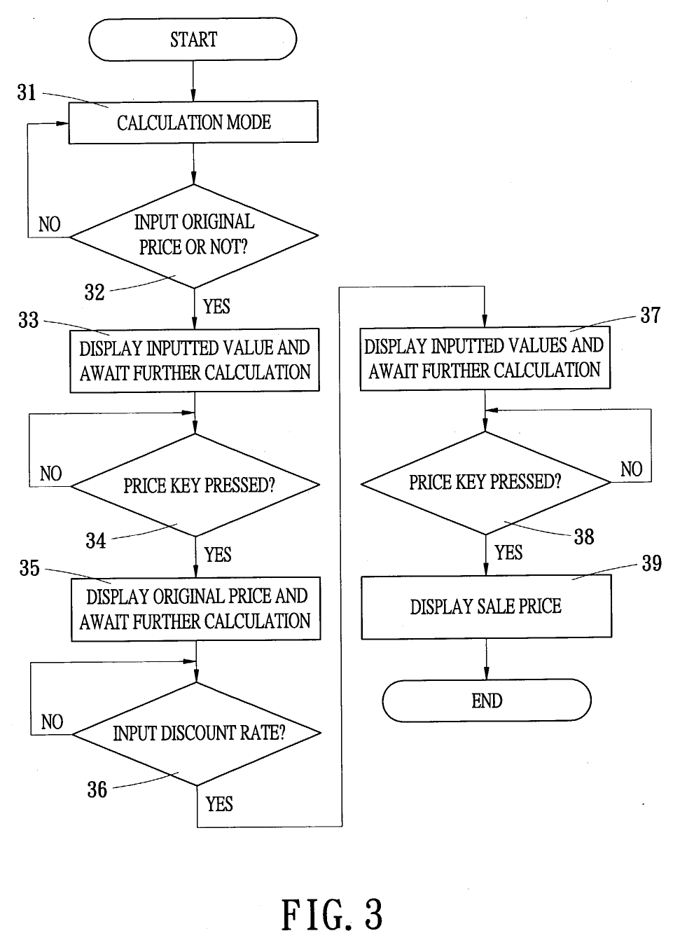

There are two approaches used by the discount calculating unit 12 for calculating merchandise discount. One is using the SET key and DISCOUNT key in combination with equations (1) and (2) to calculate sale price and the amount of discount. The other approach is using PRICE key and DISCOUNT key in combination with equations (3), (4), and (5), in which two known numbers are input to calculate an unknown number. Operation steps regarding the above-mentioned two approaches are now described in detail with reference to FIG. 2 and FIG. 3.

Please refer to FIG. 2. FIG. 2 is a flowchart showing the first approach according to the present invention. As shown in FIG. 2, the operation includes the following steps:

Step 21: The calculator 10 executes the calculating operation;

Step 22: Determine the status of the SET key to enter the setting mode. If the pressing time of the SET key exceeds a short period of time, for example, two seconds, a SET MODE is entered. If pressing of the SET key is confirmed, proceeding to Step 23. If pressing of the SET key is negative, back to Step 21;

Step 23: Input the discount rate through the input unit 13. After this, the microprocessor 11 will store the input discount rate temporarily in the random access memory 14;

Step 24: Judging if the SET key is pressed or not; If the SET key is pressed, proceeding to Step 25; If the SET key is not pressed, back to Step 24;

Step 25: Input the original price through the input unit 13. After this, the microprocessor 11 will store the input original price temporarily in the random access memory 14;

Step 26: Pressing the DISCOUNT key to display relevant sale price. The sale price is calculated by the microprocessor 11 by ordering the discount calculating unit 12 to bring the discount rate and the original price temporarily stored in the random access memory 14 into the equations (1) and (2). The results are displayed on the display screen 15. Further, when pressing the DISCOUNT key again, the display screen 15 can sequentially display sale price, the amount of discount, and the original price.

Please refer to Table 1. The operation in accordance with the first approach of the calculator 10 of the present invention is listed in Table 1. Assuming that the original price of an item is $500, and the discount rate is 10%. In operation, number keys, SET key, and the DISCOUNT key of the input unit 13 of the calculator 10 is used. The result is displayed on the display screen 15. A user can press the DISCOUNT key to show information including sale price $450 (450 SALE), the amount of discount $50 (50 DISCOUNT), and the original price $500.

TABLE 1

| Sequence | Input | Display |
|---|---|---|
| 1 | SET key | >0<% |
| 2 | 90 | >90<% |
| 3 | SET key | 90% |
| 4 | 500 | 500 |
| 5 | DISCOUNT key | 450 SALE |
| 6 | DISCOUNT key | 50 DISCOUNT |
| 7 | DISCOUNT key | 500 |

Please refer to FIG. 3. FIG. 3 is a flowchart showing the second approach according to the present invention. As shown in FIG. 3, the operation includes the following steps:

Step 31: The calculator 10 executes the calculating operation;

Step 32: Judging if the merchandise original price is inputted or not; If the original prices is inputted, proceeding to Step 33; If the original prices is not inputted, back to Step 31;

Step 33: Display the inputted numbers and await operations;

Step 34: Judging if the PRICE key is pressed or not; If the PRICE key is pressed, proceeding to Step 35; If the PRICE key is not pressed, back to Step 34;

Step 35: Display the inputted original price and await further operations. The inputted original price completed in Step 32 is stored in the random access memory 14;

Step 36: Judging if the discount rate is inputted or not; If the discount rate is inputted, proceeding to Step 37; If the discount rate is not inputted, back to Step 36;

Step 37: Display the inputted discount rate and await further operations;

Step 38: Judging if the DISCOUNT key is pressed or not; If the DISCOUNT key is pressed, storing the discount rate of Step 36 temporarily in the random access memory 14 and proceeding to Step 39; If the DISCOUNT key is not pressed, back to Step 37;

Step 39: Display the merchandise sale price on the display screen 15. The sale price is calculated by the microprocessor 11 by ordering the discount calculating unit 12 to bring the discount rate and the original price temporarily stored in the random access memory 14 into the equations (5).

Please refer to Table 2. The operation in accordance with the second approach of the calculator 10 of the present invention is listed in Table 2. Assuming that the original price of an item is $500, and the discount rate is 10%. In operation, number keys, SET key, and the DISCOUNT key of the input unit 13 of the calculator 10 is used. The result is displayed on the display screen 15. A user can press the DISCOUNT key to show information including sale price $450 (450 SALE), the amount of discount $50 (50 DISCOUNT), and the original price $500.

TABLE 1

| Sequence | Input | Display |
|---|---|---|
| 1 | 500 | 500 |
| 2 | PRICE | 500 PRICE |
| 3 | 90 | 90 |
| 4 | DISCOUNT key | 450 SALE |

When the discount calculating unit 12 calculates the sale price according to the second approach, the flowchart of FIG. 3 is operated from the known original price and known discount rate to find unknown sale price. It is appreciated that only two of the original price, discount rate, and the sale price are inputted, the third unknown value can be calculated through the second approach of FIG. 3.

To sum up, the calculating device of the present invention can calculate sale price through the first approach and the second approach. The first approach involves the use of SET key to first input the discount rate, then the DISCOUNT key to calculate the sale price and the amount of discount according to equations (1) and (2). The second approach involves the use of PRICE key, DISCOUNT key, and SALE key. According to the second approach, only two of the original price, discount rate, and the sale price is needed to find the third unknown value according to equations (3) to (5).

Moreover, the operation procedure for calculating discount of the present invention as embodied herein can be expressed by means of software procedure, which is written in recording medium. The software procedure includes first procedure code for inputting values through discount operation keys of input unit 13; second procedure code for storing the inputted values through the discount operation keys of input unit 13 in the random access memory 14; third procedure code for calculating the values stored in the random access memory 14 according to equations to find sale price, fourth procedure code for displaying the result.

It is advantageous to use the present invention since the customer or the merchant can get the sale price immediately after inputting few keys.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A calculating device capable of performing arithmetical operations for discount, the calculating device being installed in a calculator, the calculating device comprising:
a microprocessor for controlling the operations of the calculator;
a discount calculating unit electrically connected to the microprocessor, the discount calculating unit being used to perform arithmetical operations for discount;
an input unit electrically connected to the microprocessor, wherein the input unit comprises a plurality of discount operation keys installed on the calculator, and wherein when the discount operation keys are pressed orders for calculating arithmetical operations for discount are sent to the microprocessor;
a random access memory electrically connected to the microprocessor, the random access memory being used to store data generated during the arithmetical operations for discount; and
a display screen electrically connected to the microprocessor for displaying the data generated during the arithmetical operations for discount.

2. The calculating device as claimed in claim 1 wherein a plurality of pre-determined discount equations are coded in the discount calculating unit.

3. The calculating device as claimed in claim 1 wherein one of the discount operation keys is a SET key.

4. The calculating device as claimed in claim 1 wherein one of the discount operation keys is a PRICE key.

5. The calculating device as claimed in claim 1 wherein one of the discount operation keys is a DISCOUNT key.

6. The calculating device as claimed in claim 1 wherein one of the discount operation keys is a SALE key.

7. The calculating device as claimed in claim 1 wherein the display screen is a liquid crystal display (LCD) screen.

8. A calculating method for performing arithmetical operations for discount, comprising:
(a) inputting a discount value through an input unit to store the discount value in a random access memory;
(b) inputting an original price of an item on sale through the input unit to store the original price in the random access memory;
(c) pressing a DISCOUNT key of the input unit;
(d) calculating a sale price of the item on sale according to a first equation using the discount value and the original price stored in a random access memory which is performed by a microprocessor; and
(e) outputting the resultant sale price on a display screen.

9. The calculating method as claimed in claim 8 wherein a value of amount of discount is calculated by the microprocessor according to a second equation.

10. A calculating method for performing arithmetical operations for discount, wherein through the calculating method, an original price, an amount of discount, and a sale price can be calculated by inputting two values of the original price, amount of discount, and sale price to find the other, the calculating method comprising:
(a) inputting two known values of the original price, amount of discount, and sale price through an input unit to store the values in a random access memory;
(b) processing the two known values of the original price, amount of discount, and sale price by a microprocessor to find the other value of the original price, amount of discount, and sale price according to an equation; and
(c) outputting the resultant value on a display screen.
